(19) United States
(12) Patent Application Publication
(10) Pub. No.: US 2024/0349802 A1
(43) Pub. Date: Oct. 24, 2024

(54) Aerosol Generating Device Comprising a Flat-Shaped Heating Chamber and Associated Aerosol Generating Assembly

(71) Applicant: JT International SA, Geneva (CH)

(72) Inventor: Alec Wright, Guildford (GB)

(73) Assignee: JT International SA, Geneva (CH)

(21) Appl. No.: 18/684,002

(22) PCT Filed: Aug. 31, 2022
(86) PCT No.: PCT/EP2022/074150

§ 371 Date: Feb. 15, 2024

(30) Foreign Application Priority Data
Aug. 31, 2021 (EP) 21193966.5

(51) Int. Cl. A24F 40/46; A24F 40/20; H05B 3/22

(52) U.S. Cl. CPC A24F 40/46; A24F 40/20; H05B 3/22

(57) ABSTRACT

An aerosol generating device includes a heating chamber extending along a chamber axis between a closed end and an open end, the heating chamber being flat-shaped and configured to receive through its open end a flat-shaped tobacco article and defining a first portion adjacent to the closed end and a second portion adjacent to the open end, the heating chamber including at least two chamber contact walls facing each other and extending through both portions of the heating chamber, the chamber contact walls being arranged so that the distance between these walls in the second portion of the heating chamber is greater than the distance between these walls in the first portion of the heating chamber.

### FIELD OF THE INVENTION

The present invention concerns an aerosol generating device comprising a flat-shaped heating chamber. The present invention also concerns an aerosol generating assembly comprising such an aerosol generating device.

Particularly, the aerosol generating device according to the invention is configured to operate with a flat-shaped tobacco article which comprises for example a solid substrate able to form aerosol when being heated. Thus, such type of aerosol generating devices, also known as heat-not-burn devices, is adapted to heat, rather than burn, the substrate by conduction, convection and/or radiation, to generate aerosol for inhalation.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device. Devices of this type generate aerosol or vapour by heating an aerosol substrate that typically comprises moist leaf tobacco or other suitable vaporizable material to a temperature typically in the range 150° C. to 350° C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

Some of aerosol generating devices can operate with flat-shaped tobacco articles which have reduced dimensions. In some cases, the depth of such articles can be comprised between 0.5 and 2 mm. Heating efficiency of these articles may be very challenging. Particularly, ensuring a tight contact of the article with heaters while keeping its insertion/extraction easily operable for the user cannot always be achieved.

### SUMMARY OF THE INVENTION

One of the aims of the invention is to provide an aerosol generating device ensuring a high heating efficiency and allowing the user its effortless insertion/extraction.

For this purpose, the invention relates to an aerosol generating device comprising a heating chamber extending along a chamber axis between a closed end and an open end;

the heating chamber being flat-shaped and configured to receive through its open end a flat-shaped tobacco article and defining a first portion adjacent to the closed end and a second portion adjacent to the open end

the heating chamber comprising at least two chamber contact walls facing each other and extending through both portions of the heating chamber;

the chamber contact walls being arranged so as the distance between these walls in the second portion of the heating chamber is greater than the distance between these walls in the first portion of the heating chamber.

Thanks to these features, only a part of the flat-shaped tobacco article can be compressed to ensure a tight contact with the chamber contact walls. Thus, the flat-shaped tobacco article may be compressed and heated only where it is required, avoiding thus heat wasting and improving heating efficiency. Additionally, since the flat-shaped tobacco article is not compressed along its whole length, its insertion/extraction can be particularly easy for the user.

According to some embodiments, the first portion of the heating chamber is designed to receive a substrate part of the tobacco article and the second portion of the heating chamber is designed to receive at least partially a cooling part of the tobacco article.

Thanks to these features, only the substrate part of the flat-shaped tobacco article can be in tight contact with the chamber contact walls whereas its cooling part can be spaced out from the chamber contact walls. Thus, the heat exchange is decreased in the cooling part of the article making the cooling more efficient and avoiding wasting the heat where it is not required.

According to some embodiments, the chamber contact walls are designed to be in contact with at least a half, advantageously at least three quarters, of the total external area of the substrate part of the tobacco article.

Thanks to these features, the substrate part of the flat-shaped tobacco article can efficiently be heated.

According to some embodiments, the chamber contact walls are designed to be spaced from at least a half, advantageously at least three quarters, of the total external area of the cooling part of the tobacco article.

Thanks to these features, it is possible to minimize heat exchanges between the chamber contact walls and the cooling part of the tobacco article and thus, increase cooling efficiency.

According to some embodiments, each chamber contact wall presents a flat surface designed to face the tobacco article.

According to some embodiments, each chamber contact wall forms a non-zero angle with the chamber axis.

Thanks to these features, it is possible to ensure decrease cross-sectional shape of the part of the heating chamber adjacent to its closed end.

According to some embodiments, the chamber contact walls extend from the closed end to the open end of the heating chamber so as to form a V-shape.

Thanks to these features, the chamber contact walls can be particularly easily produced and assembled. Additionally, it is possible to ensure a non-homogeneous compression rate of the substrate part of the tobacco article.

According to some embodiments, in the first portion of the heating chamber the chamber contact walls extend parallel to the chamber axis.

Thanks to these features, it is possible to ensure a homogeneous compression rate of the whole substrate part of the tobacco article and avoid compression of the cooling part.

According to some embodiments, in the second portion of the heating chamber the distance between the chamber contact walls increases gradually from an end adjacent to the first portion until the open end of the heating chamber.

According to some embodiments, in the second portion of the heating chamber the chamber contact walls form a curved shape.

Thanks to these features, insertion of the tobacco article by the user can be easily performed since its substrate part is continuously compressed by the gradual narrowing of the heating chamber.

According to some embodiments, in each portion of the heating chamber, each chamber contact wall presents a flat surface designed to face the tobacco article. Additionally or alternatively, the flat surfaces of each chamber contact wall form a non-zero angle between the first portion and the second portion.

Thanks to these features, it is possible to ensure a homogeneous compression rate of the whole substrate part of the tobacco article and avoid compression of the cooling part.

According to some embodiments, the heating chamber forms a rectangular cross-sectional shape.

According to some embodiments, at least one chamber contact wall is a heating wall.

Thanks to these features, the substrate part of the tobacco article can be heated directly by one or several chamber contact walls. Additionally, in case of heating walls, the heating can be performed according to a same heating profile or different heating profiles. This can increase heating efficiency and user experience while a vaping session.

According to some embodiments, the heating chamber forms a cup shape. For example, the closed end may define a bottom of the heating chamber in the form of a cup shape, in particular facing the open end.

According to some embodiments, the heating chamber comprises a pair of parallel chamber lateral walls extending along the chamber axis. For example, the distance between the chamber lateral walls may be between 3 and 10 times greater, than any distance between the chamber contact walls.

According to some embodiments, the chamber contact walls and the chamber lateral walls are rigidly fixed one to another. For example, the chamber contact walls and/or the chamber lateral walls are fixed so that they cannot move one relatively to another.

According to some embodiments, the chamber contact walls may form, in a section comprising the chamber axis, a continuous derivable curve. In other words, for example, the chamber contact walls may be deprived of steps and/or portions extending in a plane perpendicularly to the chamber axis.

The present invention also concerns an aerosol generating assembly, comprising a flat-shaped tobacco article and an aerosol generating device as defined above, the aerosol generating device being adapted to operate with the flat-shaped tobacco article

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a perspective view of an aerosol generating assembly according to the invention, the aerosol generating assembly comprising an aerosol generating device according to the invention and a flat-shaped tobacco article usable with the aerosol generating device, the aerosol generating device comprising a heating chamber;

FIG. 2 is a perspective view of the flat-shaped tobacco article of FIG. 1;

FIG. 3 is a cross-sectional partial view according to plane III of FIG. 1, the heating chamber being according to a first embodiment of the invention;

FIG. 4 is a cross-sectional partial view according to plane IV of FIG. 1, the heating chamber being according to a second embodiment of the invention; and

FIG. 5 is a cross-sectional partial view according to plane V of FIG. 1, the heating chamber being according to a third embodiment of the invention.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of a heater element explained in further detail below. The device may be portable. “Portable” may refer to the device being for use when held by a user. The device may be adapted to generate a variable amount of aerosol, e.g. by activating the heater element for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

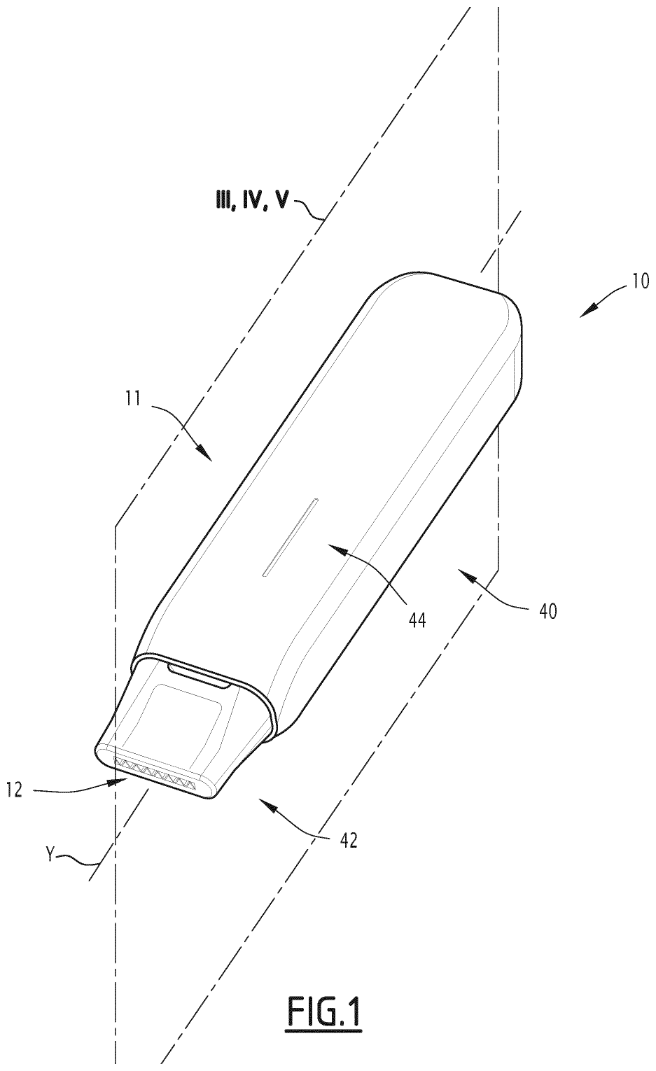

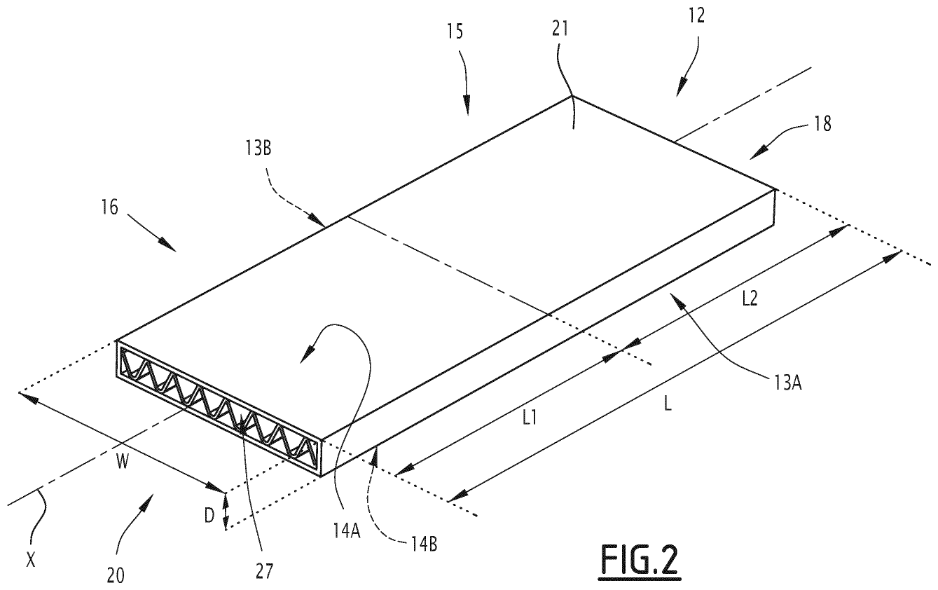

FIG. 1 shows an aerosol generating assembly 10 comprising an aerosol generating device 11 and a flat-shaped tobacco article 12, called hereinafter tobacco article 12. The aerosol generating device 11 is intended to operate with the flat-shaped tobacco article 12 which is shown in more detail on FIGS. 2.

In reference to FIG. 2, the tobacco article 12 is for example a flat-shaped cuboid extending along an article axis X and having external dimensions L×W×D. In a typical example, the length L of the tobacco article 12 according to the article axis X equals substantially to 33 mm while its width W and depth D are substantially equal respectively to 12 mm and 1.2 mm. According to different examples, the values L, W and D can be selected within a range of +/−40%, for example. The depth D of the tobacco article 12 is formed by a pair of parallel walls 13A, 13B, called hereinafter article lateral walls 13A, 13B, and the width W of the tobacco article 12 is formed by a pair of parallel walls 14A, 14B, called hereinafter article contact walls 14A, 14B. According to other embodiments of the invention, the tobacco article 12 can have any other suitable shape and/or external dimensions. For example, the tobacco article 12 may form a circular tube shape.

The tobacco article 12 comprises a substrate part 15 and a cooling part 16 arranged along the article axis X. The substrate part 15 may for example be slightly longer than the cooling part 16. For example, the length L2 of the substrate part 15 according to the article axis X may be substantially equal to 18 mm and the length L1 of the cooling part 16 according to the article axis X may be substantially equal to 15 mm. The substrate part 15 defines an abutting end 18 of the tobacco article 12 and the cooling part 16 defines a mouth end 20 of the tobacco article 12. The substrate part 15 and the cooling part 16 may be fixed one to the other by a unique wrapper extending around the article axis X. In other embodiments, the parts 15, 16 may be wrapped by different wrappers and fixed one to the other by any other suitable mean. The or each wrapper may, for example, comprise paper and/or non-woven fabric and/or aluminium. The or each wrapper may be porous or air impermeable. The or each wrapper forms a plurality of airflow channels extending inside the tobacco article 12 between the abutting end 18 and the mouth end 20.

The substrate part 15 is intended to be heated by one or several heaters (using a heating chamber in the present example) and comprises vaporizable material as defined above. According to different examples of the invention, the cooling part 16 is intended to be received partially inside a mouthpiece and partially in a heating chamber, as it will be explained in further detail below. According to other embodiments of the invention, at least the part adjacent to the mouth end 20 of the cooling part 16 forms itself a mouthpiece intended to be in contact with the user's mouth and/or lips. The cooling part 16 comprises a core 17 acting for example like a filter and/or vapour cooling mean. The core 17 may for example be a foam, or packed strands or fibres. The core 17 may be formed through an extrusion and/or rolling process into a stable shape. In a particular embodiment (not shown), the cooling part 16 defines a plurality of venting holes arranged for example according to the whole perimeter of the cooling part 16 along two axis perpendicular to the article axis X. In other words, according to this example, the venting holes are arranged on each wall of the tobacco article 12 among the article lateral walls 13A, 13B and the article contact walls 14A, 14B. According to another example, the venting holes are arranged only on the article contact walls 14A, 14B or preferably, only on one of the article contact walls 14A, 14B. In both examples, the venting holes may be aligned perpendicularly to the article axis X on the or each corresponding wall of the tobacco article 12, and can be spaced by a same distance. The venting holes allow fresh air entering inside the tobacco article 12 to achieve particular vaping/tasting effects. In a preferred embodiment, no venting hole is provided.

Referring again to FIG. 1, the aerosol generating device 11 comprises a device body 40 extending along a device axis Y. The device body 40 comprises a mouthpiece 42 and a housing 44 arranged successively along the device axis Y. According to the example of FIG. 1, the mouthpiece 42 and the housing 44 form two different pieces. Particularly, according to this example, the mouthpiece 42 is designed to be fixed on or be received in an insertion opening formed at one of the ends of the housing 44. In this case, the tobacco article 12 can be inserted inside the device 11 when the mouthpiece 42 is removed from the housing 44. According to another example (not-shown), the mouthpiece 42 and the housing 44 form one unique piece. In this case, the tobacco article 12 can be inserted inside the device 11 through for example a flow outlet. According to both examples, the mouthpiece 42 defines a through hole adapted to receive at least partially the tobacco article 12. Particularly, the through hole can be adapted to receive at least a part of the cooling part 16 of the tobacco article 12 as it is shown on FIG. 1.

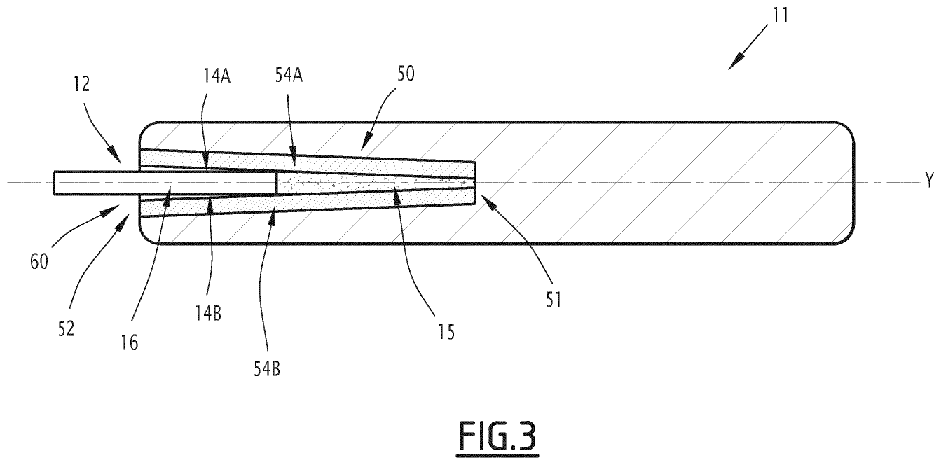

The housing 44 delimits an internal space of the device 11 receiving various elements designed to carry out different functionalities of the device 11. This internal space can for example receive a battery for powering the device 11, a control module for controlling the operation of the device 11, a heating chamber for heating the substrate part 15 of the tobacco article 12, etc. Among these elements, only the heating chamber according to different embodiments of the invention will be explained in further detail in reference to FIGS. 3 to 5.

### FIRST EMBODIMENT OF THE INVENTION

FIG. 3 shows a cross-section of the aerosol generating device 11 without the mouthpiece 42, according to plane III of FIG. 1. As it is shown on this figure, the aerosol generating device 11 comprises a heating chamber 50 extending along a chamber axis between a closed end 51 and an open end 52. The chamber axis coincides in the example of FIG. 3 with the device axis Y.

As it is also shown on FIG. 3, the heating chamber 50 can form a cup shape adapted to receive the substrate part 15 and at least partially the cooling part 16 of the tobacco article 12. Depending on different examples of the invention, the extremity of the cooling part 16 protruding from the heating chamber 50 can be received in the through hole of the mouthpiece 42 or is intended to be in contact with the user's lips and/or mouth. As the tobacco article 12, the heating chamber 50 may also form a rectangular cross-sectional shape and may comprise a pair of parallel chamber lateral walls (not shown on FIG. 3) extending along the chamber axis and a pair of chamber contact walls 54A, 54B designed to be partially in contact with the article contact walls 14A, 14B, as it will be explained in further detail below. According to different examples of the invention, the chamber lateral walls can be in contact with the article lateral walls 13A, 13B or be spaced from them. Additionally, as the tobacco article 12, the heating chamber 50 is flat-shaped which means that the distance between its lateral walls is much greater, for example between 3 and 10 times greater, than any distance between its contact walls 54A, 54B.

The heating chamber 50 may also comprise a bottom wall (not shown on FIG. 3) adjacent to each of said walls and extending perpendicularly to the chamber axis at the closed end 51. In variant, the closed end 51 of the chamber 50 is formed by a narrow section between its lateral and/or contact walls so as to abut against the abutting end 18 of the tobacco article 12 while its insertion into the chamber 50. The heating chamber 50 also defines an opening 60 at its open end 52 suitable for inserting the tobacco article 12.

Each of the chamber contact walls 54A, 54B or at least one of these walls can be a heating wall. Particularly, such a heating wall may comprise or may be in contact with a heating element connected to the battery of the device 11 and controlled by the control module of the device 11 to heat the tobacco article 12. The heating element may extend along substantially the whole surface of the heating wall or only along a part of this surface. The heating element may be formed by a ceramic heater, polyimide film heater or any other suitable heater. In case where both contact walls 54A, 54B are heating walls, the corresponding heating elements may be controlled by the control module according to a same heating profile or according to different heating profiles.

According to the first embodiment of the invention, each of the chamber contact walls 54A, 54B presents a flat surface facing the tobacco article 12 when it is inserted in the chamber 50. Additionally, at least one of chamber contact walls 54A, 54B forms a non-zero angle with the chamber axis so as the distance between these walls at the open end 52 of the chamber 50 is greater than the distance between these walls at the closed end 52 of the chamber 50. For example, the chamber contact walls 54A, 54B can be arranged symmetrically in respect with the chamber axis to form a V-shape of the chamber 50. The non-zero angle formed by the or each chamber contact wall 54A, 54B with the chamber axis may be comprised between 1° and 30°, and advantageously, between 5° and 20°.

More generally, the non-zero angle formed by the or each chamber contact wall 54A, 54B with the chamber axis is chosen so as the chamber 50 defines a first portion adjacent to the closed end 51 and adapted to receive the substrate part 15 of the tobacco article 12, and a second portion adjacent to the open end 52 and adapted to receive at least partially the cooling part 16 of the tobacco article 12, the distance between the chamber contact walls 54A, 54B in the second portion being greater than the distance between these walls 54A, 54B in the first portion.

In the first portion of the heating chamber 50, the chamber contact walls 54A, 54B are designed to be in contact with at least a half, advantageously at least three quarters, of the total external area of the substrate part 15 of the tobacco article 12. In this case, at least the end of the substrate part 15 adjacent to the closed end 51 of the chamber 50 may be compressed. Additionally, at least the end of the substrate part 15 adjacent to the cooling part 16 may be spaced from the chamber contact walls 54A, 54B.

In the second portion of the heating chamber 50, the chamber contact walls 54A, 54B are designed to be spaced from at least a half, advantageously at least three quarters, of the total external area of the cooling part 16 of the tobacco article 12. Advantageously, the chamber contact walls 54A, 54B are designed to be spaced from the total external area of the cooling part 16 of the tobacco article 12.

### SECOND EMBODIMENT OF THE INVENTION

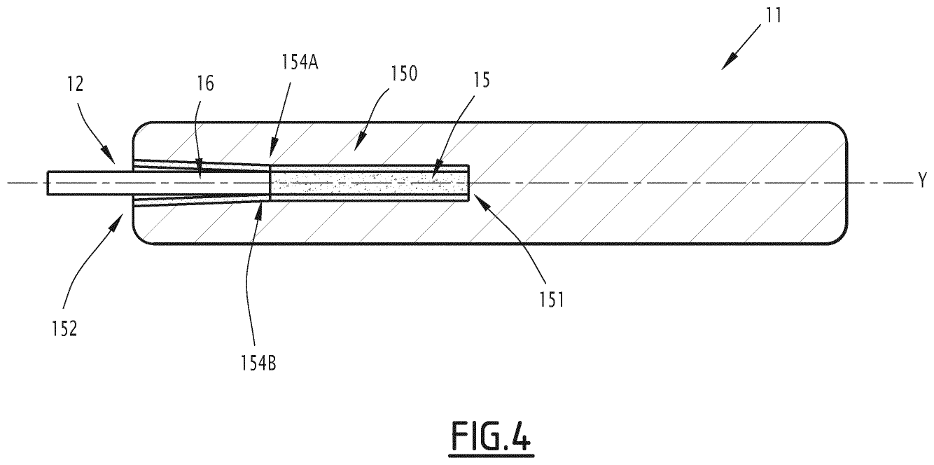

FIG. 4 shows a cross-section of the aerosol generating device 11 without the mouthpiece 42, according to plane IV of FIG. 1. As it is shown on this figure, the aerosol generating device 11 comprises a heating chamber 150 according to a second embodiment, which is similar to the heating chamber 50 according to the first embodiment except the features explained in detail below. Particularly, as the heating chamber 50 according to the first embodiment, the heating chamber 150 extends along a chamber axis between a closed end 151 and an open end 152. Additionally, as in the previous case, the chamber axis coincides in the example of FIG. 4 with the device axis Y.

Also as in the previous case, the heating chamber 150 according to the second embodiment comprises two chamber contact walls 154A, 154B designed to be partially in contact with the tobacco article 12. Also as in the previous case, the heating chamber 150 defines a first portion adjacent to the closed end 151 and adapted to receive the substrate part 15 of the tobacco article 12, and a second portion adjacent to the open end 152 and adapted to receive partially the cooling part 15 of the tobacco article 12. The chamber contact walls 154A, 154B are arranged so as the distance between these walls in the second portion of the heating chamber 150 is greater than the distance between these walls in the first portion of the heating chamber 150.

Contrary to the previous case, the chamber contact walls 154A, 154B extend parallel to the chamber axis in the first portion and with a non-zero angle in the second portion. Particularly, in the first portion, the chamber contact walls 154A, 154B may be in contact with substantially the total external area of the substrate part 15 of the tobacco article 12 and in some case, may slightly compress this substrate part 15. In the second portion, the chamber contact walls 154A, 154B may be spaced from substantially the total external area of the cooling part 15. Additionally, in the second portion, the distance between the chamber contact walls 154A, 154B may increase gradually from an end adjacent to the first portion until the open end 152 of the heating chamber 150.

For this purpose, each chamber contact wall 154A, 154B may present two flat segments: one arranged in the first portion parallel to the chamber axis and the other arranged in the second portion with a non-zero angle with the chamber axis. The segments of a same wall may be formed by flexing a unique flat piece along a line separating the first and the second portions of the heating chamber 152. In variant, the segments of a same wall can be formed by two separated flat pieces which may be fixed or hinged together.

### THIRD EMBODIMENT OF THE INVENTION

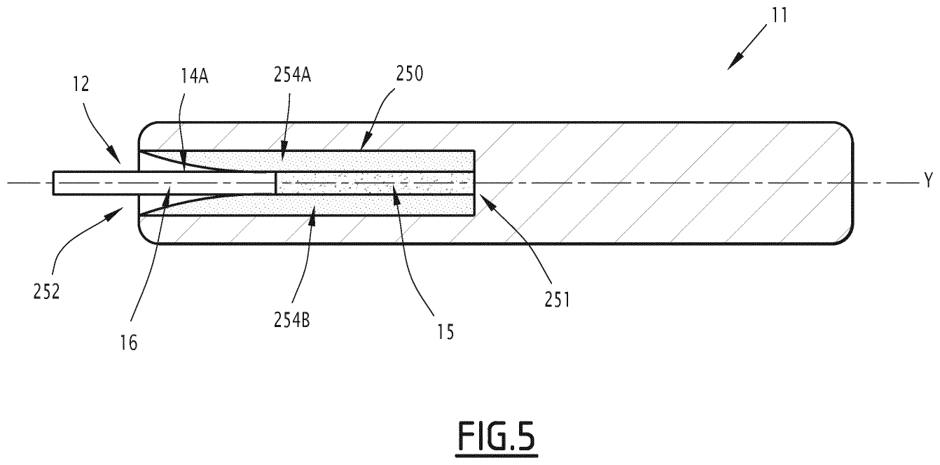

FIG. 5 shows a cross-section of the aerosol generating device 11 without the mouthpiece 42, according to plane V of FIG. 1. As it is shown on this figure, the aerosol generating device 11 comprises a heating chamber 250 according to a third embodiment, which is similar to the heating chambers 50, 150 according to the first and second embodiments except the features explained in detail below. Particularly, as the heating chambers 50, 150 according to the first and the second embodiments, the heating chamber 250 extends along a chamber axis between a closed end 251 and an open end 252. Additionally, as in the previous cases, the chamber axis coincides in the example of FIG. 5 with the device axis Y.

Also as in the previous cases, the heating chamber 250 according to the third embodiment comprises two chamber contact walls 254A, 254B designed to be partially in contact with the tobacco article 12. Also as in the previous cases, the heating chamber 250 defines a first portion adjacent to the closed end 251 and adapted to receive the substrate part 15 of the tobacco article 12, and a second portion adjacent to the open end 252 and adapted to receive partially the cooling part 15 of the tobacco article 12. The chamber contact walls 254A, 254B are arranged so as the distance between these walls in the second portion of the heating chamber 250 is greater than the distance between these walls in the first portion of the heating chamber 250.

Contrary to the previous cases, the chamber contact walls 254A, 254B extend parallel to the chamber axis in the first portion and form a curved shape in the second portion. Particularly, in the first portion, the chamber contact walls 254A, 254B may be in contact with substantially the total external area of the substrate part 15 of the tobacco article 12 and in some case, may slightly compress this substrate part. In the second portion, the distance between the chamber contact walls 254A, 254B may increase gradually from an end adjacent to the first portion until the open end 152 of the heating chamber 150.

For this purpose, each chamber contact wall 154A, 154B may present a flat segment in the first portion parallel to the chamber axis and a curved segment arranged in the second portion. As for the second embodiment, the segments may form a unique piece or two separated pieces fixed together.

### OTHER EMBODIMENTS OF THE INVENTION

Other embodiments of the invention and notably of the heating chamber are still possible. Some embodiments may correspond to a combination of the previous embodiments. For example, in some embodiments, the chamber contact walls may be realized according to the features described in relation with different embodiments above.

1. An aerosol generating device comprising a heating chamber extending along a chamber axis between a closed end and an open end;
the heating chamber configured to receive through the open end a tobacco article and defining a first portion adjacent to the closed end and a second portion adjacent to the open end;
the heating chamber comprising at least two chamber contact walls facing each other and extending through both portions of the heating chamber;
the at least two chamber contact walls being arranged so that a distance between the at least two chamber contact walls in the second portion of the heating chamber is greater than a distance between the at least two chamber contact walls in the first portion of the heating chamber.

2. The aerosol generating device according to claim 1, wherein the first portion of the heating chamber is configured to receive a substrate part of the tobacco article and the second portion of the heating chamber is configured to receive at least partially a cooling part of the tobacco article.

3. The aerosol generating device according to claim 2, wherein the at least two chamber contact walls are configured to be in contact with at least a half of a total external area of the substrate part of the tobacco article.

4. The aerosol generating device according to claim 2, wherein the at least two chamber contact walls are configured to be spaced from at least a half of a total external area of the cooling part of the tobacco article.

5. The aerosol generating device according to claim 1, wherein each of the at least two chamber contact walls presents a flat surface configured to face the tobacco article.

6. The aerosol generating device according to claim 1, wherein each of the at least two chamber contact walls forms a non-zero angle with the chamber axis.

7. The aerosol generating device according to claim 5, wherein the at least two chamber contact walls extend from the closed end to the open end of the heating chamber so as to form a V-shape.

8. The aerosol generating device according to claim 1, wherein in the first portion of the heating chamber the at least two chamber contact walls extend parallel to the chamber axis.

9. The aerosol generating device according to claim 8, wherein in the second portion of the heating chamber the distance between the at least two chamber contact walls increases gradually from an end adjacent to the first portion until the open end of the heating chamber.

10. The aerosol generating device according to claim 9, wherein in the second portion of the heating chamber the at least two chamber contact walls form a curved shape.

11. The aerosol generating device according to claim 9, wherein:
in each portion of the heating chamber, each of the at least two chamber contact walls presents a flat surface configured to face the tobacco article; and
the flat surfaces of each of the at least two chamber contact walls form a non-zero angle between the first portion and the second portion.

12. The aerosol generating device according to claim 1, wherein the heating chamber forms a rectangular cross-sectional shape,
the heating chamber comprising a pair of parallel chamber lateral walls extending along the chamber axis.

13. The aerosol generating device according to claim 1, wherein at least one of the at least two chamber contact walls is a heating wall.

14. The aerosol generating device according to claim 1, wherein the heating chamber forms a cup shape.

15. An aerosol generating assembly, comprising a tobacco article and the aerosol generating device according to claim 1, the aerosol generating device being adapted to operate with the tobacco article.

16. The aerosol generating device according to claim 12, wherein a distance between the chamber lateral walls is between 3 and 10 times greater than any distance between the at least two chamber contact walls.
